(19) United States
(12) Patent Application Publication
(10) Pub. No.: US 2004/0105678 A1
(43) Pub. Date: Jun. 3, 2004

(54) Method and apparatus for providing simultaneous channel power equalization and monitoring

(76) Inventor: Xiang-Dong Cao, Boca Raton, FL (US)

Correspondence Address: Xiang-Dong Cao, 8790 Twin Lake Drive, Boca Raton, FL, 33496, US

(21) Appl. No.: 10/307,089

(22) Filed: Nov. 29, 2002

(51) Int. Cl. H04J 14/02

(52) U.S. Cl. 398/84

(57) ABSTRACT

A dynamic channel power equalization arrangement compensates for uneven channel powers of a wavelength multiplexed optical signal using diffractive gratings and semiconductor attenuator. A novel optical design is used to provide power equalization function and optical spectrum analyzer function in one single optical arrangement, as compared to the prior art in which there is only the power equalization function in such devices. This invention provides a simple cost-effective means for a complete solution for managing individual channel powers of wavelength-division multiplexed (WDM) signals.

### CROSS REFERENCE TO RELATED APPLICATIONS

Not applicable

### STATEMENT REGARDING FEDERALLY SPONSORED RESEARCH AND DEVELOPMENT

Not applicable

### REFERENCE TO SEQUENCE LISTING, A TABLE OR A COMPUTER PROGRAMM LISTING COMPACT DISK APPENDIX

Not applicable

### BACKGROUND OF THE INVENTION

The present invention relates to method and apparatus for providing dynamic gain equalization (DGE) in high-speed optical transmission networks and systems.

High capacity optical fiber transmission systems suffer from un-flat gain or loss during transmission, which strongly limits the transmission distances as well total capacity. There are four fundamental sources that cause uneven wavelength or frequency channel power levels. First, the optical transmission fiber has wavelength-dependent loss due to Rayleigh scattering. Second, optical amplifiers used to compensate for fiber loss have certain amount of gain tilt or ripples. Depending on the input optical power, optical amplifiers such as Erbium-doped fiber amplifiers (EDFAs) have different output gain profile called dynamic gain tilt. Third, optical components such as optical multiplexers/de-multiplexers, optical add-drop filters and other components can contribute to pass-band loss ripples. Finally, optical nonlinearities such as stimulated Raman scattering (SRS) and four-wave mixing (FWM) also induce tilt and ripples among channel powers. In optically amplified dense wavelength-division multiplexing (DWDM) systems, the un-flattened gain or loss will cause un-equal optical signal to noise ratio, which results in limited total bandwidth and transmission distance. Therefore, it is important to dynamically compensate for un-even power levels to increase system capacity and reach.

There are a few different approaches that provide solutions for dynamic gain equalizations (DGEs). For example, one technique based upon acoustic-optical tunable filtering (AOTF) has been commercialized. A few AOTF filters combined together can be used to equalize power level of input optical DWDM channels to certain bandwidth resolution and residual power flatness. Due to the finite number of cascaded filters used, the resolution of AOTF-based dynamic gain equalizers is limited. Another drawback is the control algorithm is not trivial. Cascaded Mach-Zender filters can also be used to equalize optical power levels of a multi-wavelength DWDM signal. In addition to the slow thermal controls, the polarization dependence and difficult control mechanism make this type of device difficult to use in practical systems. Other types of DGEs use optical multiplexer and de-multiplexers to separate wavelength channels, and use variable optical attenuators to equalize channel power. The multiplexers and de-multiplexers can be based on bulk-optics or arrayed waveguide (AWGs), and the VOAs can be liquid-crystal based or microelectromechanical system (MEMs) based. The advantage is ease of control compared to optical filtering techniques, while the drawbacks are the pass-band narrowing due to the transfer function of MUX/DEMUX, and more importantly high cost. Although the above-mentioned methods all have their own pros and cons, they all share one important common drawback, that is, none of these methods provide any feedback control signals. In other words, the user have to use another external monitoring device to measure the flatness of the compensated signal and feed the error signal back to the DGE devices. Lack of integrated monitoring mechanism not only increase overall cost and size for completed dynamic gain equalization, also complicated DGE designs.

It is important to provide a dynamic gain equalization mechanism which (a) dynamically equalizes power levels of all wavelength channels, (b) does not have effects of channel pass-band narrowing, (c) has a integrated channel power level monitoring.

### BRIEF SUMMARY OF THE INVENTION

The present invention is directed to method and apparatus for providing dynamic gain equalization (DGE) using a novel technique based on diffractive gratings and integrated variable optical attenuator that simultaneously measures optical powers. Compared to prior art, the present invention has the advantages of (a) low cost, (b) compact size, (c) no pass-band narrowing, (d) integrated low-cost channel power analyzer.

Viewed from one aspect, the present invention is directed to an optical arrangement for providing dynamic gain equalization to a received distorted input signal comprising N wavelength multiplexed channels. The optical arrangement comprises a pair of diffractive gratings, a quarter wave-plate, a variable optical attenuator, an integrated power monitor, a 90-degree optical prism, and two collimators. The two optical diffractive gratings are parallel to each other with a pre-determined distance between them. The input optical signal, consisting of N wavelength channels, is reshaped by the grating-pair after being collimated into free space in such a way that each wavelength channel is transformed into a parallel beam-let. Each wavelength beam-let is separated from each other by a predetermined amount. A variable optical attenuator is placed after the second grating so that it can attenuate each wavelength channel and provide power measurement of each channel. A 90-degree prism is placed after the variable optical attenuator to change the beam height and re-direct the beam to the 180 degrees direction with respect to input beam to the prism. The backward-propagating beam pass through the power-monitoring portion of the VOA, which measures the resulting power levels of all channels. A quarter wave-plate is inserted after the second grating to eliminate polarization dependence. The attenuator, made of semiconductor material, absorbs input optical beam. The amount of absorption is dependent upon the applied voltage. The electrodes on the attenuator are patterned in such a way that they form an array of independent unit to address a predetermined beam width. There is separate set of electrodes on the power-monitoring portion of the semiconductor attenuator for the returned beam. This set of electrodes have the same bias voltage so that the power levels of all channels can be monitored.

The invention will be better understood from the following more detailed description taken with the accompanying drawings and claims.

### BRIEF DESCRIPTION OF THE SEVERAL VIEWS OF THE DRAWING

FIG. 1 is a block diagram of a simultaneous channel power adjustment and measurement arrangement in accordance with a first embodiment of the present invention.

FIG. 2a graphically shows the top view of the design of the semiconductor attenuator element used in the arrangement FIG. 1.

FIG. 2b graphically shows the side view of the design of the semiconductor attenuator element used in the arrangement FIG. 1.

FIG. 2c graphically shows the front view of the design of the semiconductor attenuator element used in the arrangement FIG. 1.

The drawings are not necessarily to scale.

### DETAILED DESCRIPTION OF THE INVENTION

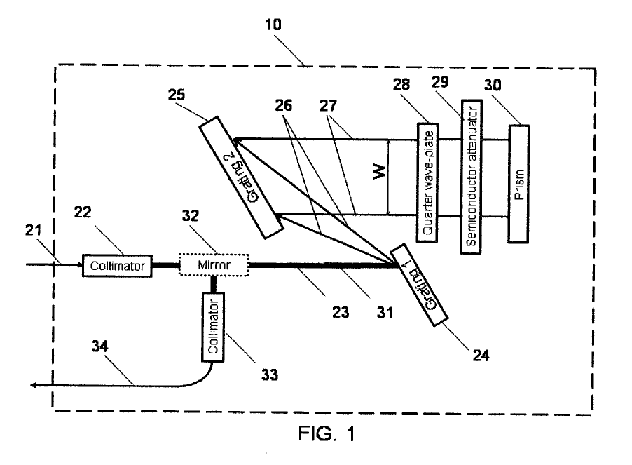

Referring now to FIG. 1, there is shown a block diagram of a dynamic gain equalization arrangement 10 (shown within a dashed line rectangle) in accordance with a first embodiment of the present invention. The dynamic gain equalization arrangement 10 comprises an input collimator 22, two parallel optical gratings 24 and 25, a quarter-wave plate 28, a semiconductor attenuator 29 and a 90-degree prism 30. The output of the collimator 22 is a collimated optical beam 23 in free space, which is aligned to the first grating 26. Optical beam from collimator 22 propagates directly onto Grating 24 wit a predetermined incident angle. Grating 24 and 25 are parallel to each other. The diffracted optical beam from grating 24 propagates towards to the second grating 25, which further diffracts the incoming beam 26 to an optical beam 27 that is parallel to beam 23. A quarter-wave plate 28, a semiconductor attenuator 29 and a 90-degree optical prism are serially placed in the path of beam 27. The 90-degree optical prism 30 reflects the input optical beam towards 180 degrees direction with respect to the input beam, and simultaneously shifts the beam in vertical direction.

In operation, a power level distorted optical input signal is received by the dynamic gain equalization arrangement 10 via the optical input fiber 21, which is coupled to the input of the collimator 22. The optical input signal comprises N wavelength multiplexed channels. The collimator 22 couples the optical signal from fiber 21 and collimates the output beam to a pre-determined beam width. The collimated beam 23 from the collimator 22 propagates onto the first grating 24 and is spatially dispersed into beam 26. The second grating 25 is placed parallel to grating 24 with a predetermined angle with respect to beam 23, it intersects the incoming beam 26, and diffracts into a collimated beam 27. The cross-section of beam 29 is elliptical due to grating diffraction. As a result of the mentioned double diffraction, the N wavelength-multiplexed signal is spatially de-multiplexed in such a way that lower wavelength channels are placed at the top of beam 27, while longer wavelength channels are placed at the bottom of the beam 27. The quarter wave-plate 28 is placed in such a way that the reflected beam has its polarization rotated 90 degrees after the second pass so that the polarization dependence of the optical setup, especially the gratings can be eliminated. The semiconductor attenuator 29 gives rise to a certain amount of attenuation to the transmitted optical beam, and there is a variation in attenuations depending upon the voltages provided for each electrode. The 90-degree optical prism 30 reflects the input optical beam towards 180 degrees direction with respect to the input beam, and simultaneously shifts the beam in vertical direction. The returned beam propagates onto the semiconductor attenuator at different height compared to the forward beam, and passes through a second set of transparent electrode array that provides channel power information. The returned beam further propagates through the quarter wave-plate 28, grating 25 and 24, and becomes a backward propagating beam 31, which is shifted in height compared to input beam 23. A mirror 32 with proper height is used to re-direct the returned beam to a second collimator 33, which couples the input optical signal further to an output fiber 34.

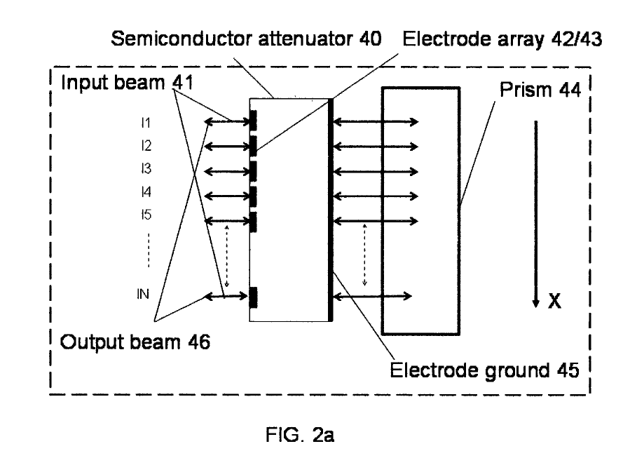

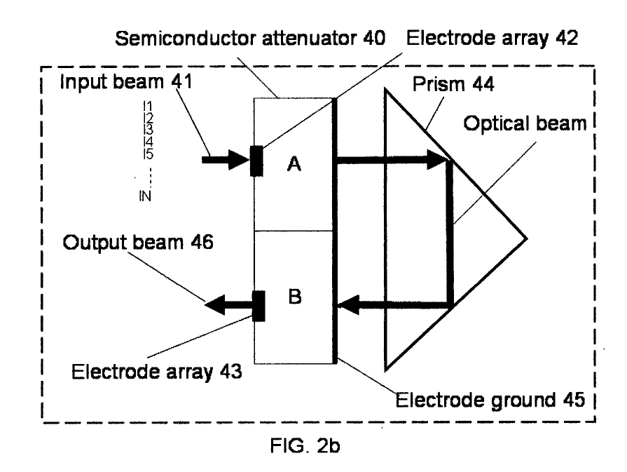

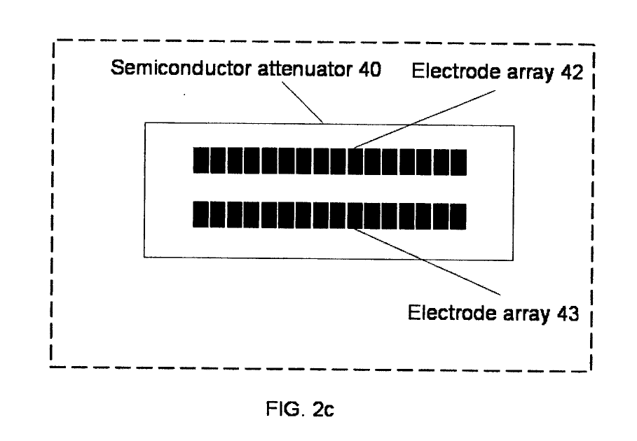

The functional diagram of the semiconductor attenuator 31 is shown in FIG. 2. Referring to FIG. 2a, which is the top view of FIG. 1, the input beam 41 consists of N spatially separated beam lets with their wavelengths ordered across X direction. After propagating through the first electrode array on the semiconductor attenuator 40, each beam let experiences different amount attenuation depending on the voltage applied to the transparent electrodes covering each beam let. An array of transparent electrodes 42 are placed in the front of the semiconductor attenuator 40, and a common ground electrode 45 is placed at the back-side of semiconductor attenuator 40. A 90-degree prism 44 shifts the optical beam in vertical direction, the direction of viewing, and turns the beam 180 degress with respect to the input direction so that the returned beam propagates onto the second set of electrode array 43 on the semiconductor attenuator 40. Referring to FIG. 2b, the optical set-up is shown viewing from the side. The optical beam is shown to make a U-turn by the Prism 44. The semiconductor attenuator 40 is divided into two parts, A and B, representing the optical attenuation and power monitoring, respectively. However, it does not mean semiconductor attenuator 40 has to be physically consists of two parts, it can be made of a single semiconductor material. FIG. 2c shows the front view of semiconductor attenuator 40. The output beam 46 will have its intensity or power level modified when a set of voltage signal is applied to the electrode array 42. The electric current (or photo-current) of electrode array 43 is dependent on the optical power received by each electrode element, and can be used to measure the average power of each beam let. The photo-current from electrode array 43 is proportional to the received optical power, and can be used as feedback signal to control the voltages applied to the electrode array 42 so that the final output power levels of all wavelength channels are set to desired values.

Semiconductor attenuator 40 can be designed using a variety of opto-electrical properties of semiconductor materials. For example, free-carrier absorption (FCA) gives rise to enhanced attenuation by applying an external voltage across the active semiconductor regime. There are commercial variable optical attenuators (VOAs) utilizing FCA properties. Other potential useful properties that can be used in this Invention are the electro-absorption effects, or known as Franz-Keldysh and Stark effects. Both effects result in absorption of incident light with photon energies smaller than the band-gap with the application of an electric field.

The present Invention simultaneously provides the optical power level adjustment and measurement capabilities in a single optical design, which results in cost-effectiveness and compactness of such devices.

It is to be appreciated and understood that the specific embodiments of the invention described hereinabove are merely illustrative of the general principles of the invention. Various modifications may be made by those skilled in the art which are consistent with the principles set forth.

What I claim is:

1. An optical arrangement for providing simultaneous dynamic gain equalization and channel measurement to a received distorted input signal comprising n wavelength multiplexed channels, the arrangement comprising:
a pair of parallel diffractive gratings to separate each wavelength into parallel beam-let in space;
a semiconductor attenuator that adjusts all channel power levels when a spatial voltage profile is provided and simultaneously measures all channel powers;
a quarter-wave plate properly placed between the second grating and the semiconductor attenuator to eliminate polarization dependence of the optical arrangement;
two collimators are used to collimate the signal from the input fiber to a beam with proper beam width that is optimal for the gratings;
a 90-degree prism placed after the semiconductor attenuator is used to move the beam up or down and reflect the optical beam back at the same time so that the returning beam will be parallel to the input beam but shifted in height;
an optical mirror used to separate the returned optical beam from the input or forward optical beam, and re-directs the optical beam to an output optical collimator.

2. The optical arrangement of claim 1 wherein the parallel gratings are arranged in such a way that the input beam is converted to a broader beam that is parallel to the input optical beam. Each wavelength or channel of the input signal is displaced in the output beam parallel to each other.

3. The optical arrangement of claim 1 wherein the quarter-wave plate is arranged so that the reflected beam will have its polarization rotated 90 degrees with respect to the input to the wave-plate. Therefore, the polarization dependence of this optical arrangement will be eliminated.

4. The optical arrangement of claim 1 wherein the semiconductor attenuator provides varying attenuation across its width so that the space-displaced beam with different wavelengths will experience different attenuation. There is an array of transparent electrodes properly spaced on the semiconductor attenuator to provide independent attenuations to the area covered by each electrode. The photo-current from each electrode provides a means to measure the optical power.

5. The optical arrangement of claim 1 wherein the semiconductor attenuator provides power measurement across its width by using second array of electrodes properly spaced on the semiconductor attenuator to provide independent power monitoring to the area covered by each electrode. The photo-current from each electrode provides a means to measure the optical power. The second array of transparent electrode array is parallel to the first transparent electrode array, but without a pre-determined distance between them.

6. The optical arrangement of claims 1 further comprising a 90-degree prism placed after the semiconductor attenuator is used to move the beam up or down and reflect back at the same time so that the returning beam will be parallel to the input beam but shifted in height. The returned optical beam from the prism therefore passes through the power monitoring electrode array on the semiconductor attenuator.

7. The optical arrangement of claims 1 wherein a collimator is used to collimate the signal from the input fiber to a beam with proper beam width that is optimal for the gratings.

8. The optical arrangement of claims 1 further comprising an optical mirror used to separate the returned optical beam from the input or forward optical beam, and re-directs the optical beam to an output optical collimator.

9. The optical arrangement of claims 1 further comprising a second optical collimator used to couple the returned optical beam to an output optical fiber.
